(19) United States
(12) Patent Application Publication
(10) Pub. No.: US 2006/0011538 A1
(43) Pub. Date: Jan. 19, 2006

(54) System and method for bacterial treatment

(75) Inventors: Frederick P. Mussari, Melbourne, FL (US); Wilfried Schmitz, Jacksonville, FL (US)

Correspondence Address: MORRISON & FOERSTER LLP, 1650 TYSONS BOULEVARD, SUITE 300, MCLEAN, VA, 22102, US

(73) Assignee: Bio-Chem Resources, St. Augustine, FL (US)

(21) Appl. No.: 11/184,072

(22) Filed: Jul. 19, 2005

Related U.S. Application Data
(60) Provisional application No. 60/588,807, filed on Jul. 19, 2004.

(51) Int. Cl. C02F 3/00

(52) U.S. Cl. 210/608; 210/610

(57) ABSTRACT

A method utilizing bacterial strains to degrade fats, oils, and greases in grease interceptors is provided. The method uses bacteria commonly known in the art, and is combined with a mechanism to restock or reseed the trap at intervals, and to inactivate or remove bacteria that have mutated and are no longer effective at metabolizing fats, oils, and greases.

### CROSS REFERENCE TO RELATED APPLICATIONS

This application claims the priority of U.S. Provisional Application Ser. No. 60/588,807, filed Jul. 19, 2004. This application is incorporated by reference herein in its entirety.

### BACKGROUND OF THE INVENTION

1. Field of the Invention

The present invention relates to the treatment of restaurant or food-preparation facility grease traps, or interceptors. The invention specifically improves upon the current method of delivering desirable bacteria to the trap, and provides a mechanism by which the organisms can be inactivated once they lose their effectiveness.

2. General Background

In the treatment of grease traps, it is common practice to separate fats, oils, and greases from gray water. The water effluent is discharged to a municipal sewer or drain-field, and the fats, oils, and greases are retained and pumped out to be removed.

Given that the grease traps typically have a limited capacity (300-1200 gallons), once the traps fill with grease, they are no longer functional and must be emptied.

There is a need in the industry for a treatment that works to degrade or digest the fats/oils/greases in the trap so that the time between pumping can be extended. There are numerous treatments available to perform this function, and all of them have several common flaws; the organisms, after a short period of time, undergo spontaneous mutations which render them ineffective, or less effective, for their intended purpose. There is a need for a method by which the mutated organisms are inactivated so that they do not compete with beneficial bacteria once they are re-introduced into the trap.

There is also a problem with beneficial organisms being killed by common cleaners, or bleach which enters the trap from the kitchens. Two methods are commonly used to deal with this problem; introduce liquid into the traps via the drain inside the facility using a timed-dose system, or place the beneficial bacteria into a solid or block form which slowly dissolves over time, adding fresh bacteria to the trap on a continuous basis. The liquid dosing method requires plumbing modifications and a pumping system to dispense the material. The process of pressing or extruding the bacteria in a solid form is that the process of manufacturing subjects the bacteria to pressure and heat which kill the organisms. This patents also teaches a method of manufacturing blocks, or ‘pucks’ in a solid form using a synthetic detergent base that is not harmful to the organisms and can be extruded in a solid form without the degree of pressure or heat which will be harmful to the bacteria, thereby delivering a high percentage of viable organisms into the trap.

### SUMMARY OF THE INVENTION

The present invention provides an improved method of treating grease traps that teaches the use of novel method of manufacturing solid forms containing bacteria that is non-harmful to the organisms and an inactivation mechanism to eliminate the organisms once they are not longer effective for the purpose of degrading fats, oils, and greases.

Chlorine dioxide is known to be a potent biocide, with well-known biocidal properties. Synthetic detergent bases can be used as a ‘binder’ to extrude pieces without the use of pressures or temperatures that would be harmful to the organisms.

### DETAILED DISCLOSURE OF THE PREFERRED EMBODIMENTS

The subject invention is directed to novel methods of treating restaurant or food preparation facility grease traps. The subject methods utilize chlorine dioxide and a synthetic detergent base for the inactivation of organisms that are no longer efficacious, and for the preparation of the bacteria for introduction into the trap.

One embodiment of the subject invention is directed to the addition of the bacteria into the trap in a liquid form.

In the preferred embodiment, the addition of the bacteria is carried out by simply inserting a solid piece (puck or block) containing the organisms directly into the trap through a service opening.

In the preferred method, organisms are inactivated using chlorine dioxide after spontaneous mutations have rendered them less effective at degrading fats, oils, and greases.

What is claimed is:

1. A method of treating grease traps utilizing bacterial strains, comprising:
inactivating the bacteria;
re-seeding the trap with beneficial organisms after a predetermined period of time.

2. The method of claim 1 wherein the bacteria are seeded in a liquid form.

3. The method of claim 1 wherein the re-seeding bacteria are introduced into the trap in a solid, or block form.

4. The method of claim 3 wherein the solid containing the bacteria is manufactured using a synthetic detergent base material as a binder and the material is extruded or formed, requiring low pressure and temperature as to not be harmful to the bacteria.

5. The method of claim 4 wherein the binder also contains a nitrogen source to facilitate anaerobic respiration of the bacteria.

6. The method of claim 1 wherein the mechanism to inactivate the bacteria is comprised of introducing chlorine dioxide into the trap.

7. The method of claim 6 wherein the chlorine dioxide is introduced in a liquid form.

8. The method of claim 6 wherein the chlorine dioxide is introduced in a solid form which generates ClO2 when dissolved in water.

9. The method of claim 8 wherein the solid form comprises sodium chlorite or sodium chlorate, an acid, and a halogen donor.
